(19) United States
(12) Patent Application Publication
(10) Pub. No.: US 2025/0229471 A1
(43) Pub. Date: Jul. 17, 2025

(54) MULTILAYERED FILM

(71) Applicant: BOREALIS AG, Vienna (AT)

(72) Inventors: Jingbo WANG, Linz (AT); Friedrich BERGER, Linz (AT); Arnaud ALABRUNE, Courbevoie (FR); Chantal SEMAAN, Barcelona (ES); Anthony BERTHELIER, Courbevoie (FR)

(73) Assignee: BOREALIS AG, Vienna (AT)

(21) Appl. No.: 18/853,881

(22) PCT Filed: Apr. 4, 2023
(86) PCT No.: PCT/EP2023/058737

§ 371 Date: Oct. 3, 2024

(30) Foreign Application Priority Data
Apr. 6, 2022 (EP) 22166862.7

(51) Int. Cl. B29C 48/00; B29B 9/06; B29C 48/08; B29C 48/10; B29C 48/21; B29K 23/00; B29K 105/00; B29L 9/00

(52) U.S. Cl. CPC B29C 48/022; B29C 48/08; B29C 48/21; B29B 9/06; B29C 48/10; B29K 2023/0633; B29K 2023/08; B29K 2105/0085; B29K 2105/0088; B29K 2995/0012; B29K 2995/0063; B29K 2995/0089; B29L 2009/00

(57) ABSTRACT

The present disclosure relates to a specific multilayered film including a skin layer, a core layer and a sealing layer; wherein the core layer includes (a) 5 to 40 wt. % based on the total weight of the core layer of a specific metallocene-catalysed multimodal polyethylene copolymer and (b) 60 to 95 wt.-% based on the total weight of the core layer of a specific multimodal Ziegler-Natta catalysed linear low density polyethylene wherein components (a) and (b) add up to 100 wt.-%. The present disclosure further relates to the use of the multilayered film as packaging material.

The present invention relates to a specific multilayered film comprising a skin layer (SKL), a core layer (CL) and a sealing layer (SL), wherein the core layer (CL) comprises (a) 5 to 40 wt.-% based on the total weight of the core layer (CL) of a specific metallocene-catalysed multimodal polyethylene copolymer (MMCP) and (b) 60 to 95 wt.-% based on the total weight of the core layer (CL) of a specific multimodal Ziegler-Natta catalysed linear low density polyethylene (ZNCP) wherein components (a) and (b) add up to 100 wt.-%. The present invention further relates to the use of said multilayered film as packaging material.

Polyethylenes are widely used everywhere in daily life, like packaging, due to their excellent cost/performance ratios. Due to the different requirements nowadays multilayered articles with different type of materials are used, which from one side serve the needs, but have the disadvantage that recycling of these articles is difficult. From a recycling point of view, mono-material solutions would be preferred. At the same time the performance of the materials should not diminish.

Multilayered films and sealing compositions for producing such films are already known in the prior art.

WO 2012/061168 A1 relates to a sealant composition, method of producing the same, articles made therefrom, and method for forming such articles. The sealant composition comprises: (a) from 70 to 99.5 wt.-% of an ethylene/alpha-olefin interpolymer composition, based on the total weight of the sealant composition, wherein said ethylene/alpha-olefin interpolymer composition comprises an ethylene/alpha-olefin interpolymer, wherein the ethylene/alpha-olefin interpolymer has a Comonomer Distribution Constant (CDC) in the range of from 15 to 250, and a density in the range of from 0.875 to 0.963 g/cm³, a melt index (12) in a range of from 0.2 to 20 g/10 minutes, and long chain branching frequency in the range of from 0.02 to 3 long chain branches (LCB) per 1000 C; (b) from 0.5 to 30 wt.-% of a propylene/alpha-olefin interpolymer composition, wherein said propylene/alpha-olefin interpolymer composition comprises a propylene/alpha-olefin copolymer or a propylene/ethylene/butene terpolymer, wherein said propylene/alpha-olefin copolymer has a crystallinity in the range of from 1 percent by weight to 30 wt.-%, a heat of fusion in the range of from 2 Joules/gram to 50 Joules/gram, and a DSC melting point in the range of 25° C. to 110° C.

EP 0 575 465 A1 refers to heat sealable compositions suitable for film and film structures comprising: (a) from 30 to 70 wt.-% of a low melting polymer comprising an ethylene based copolymer having a density of from 0.88 g/cm³ to 0.915 g/cm³, a melt index of from 1.5 dg/min to 7.5 dg/min, a molecular weight distribution no greater than 3.5, and a composition distribution breath index greater than 70 percent; and, (b), being different from (a), from 70 to 30 wt.-% of a propylene based polymer having from 88 mol-% to 100 mol-% propylene and from 12 mol-% to 0 mol-% of an alpha-olefin other than propylene.

WO 2021/204799 A1 relates to a film comprising a sealing layer comprising a polyethylene A comprising moieties derived from ethylene and moieties derived from an a-olefin comprising 4 to 10 carbon atoms, the polyethylene A having a density of ≥870 and ≤920 kg/m³, preferably of ≥900 and ≤920 kg/m³, as determined in accordance with ASTM D792 (2013), wherein the polyethylene A has: a fraction of material that is eluted in analytical temperature rising elution fractionation (a-TREF) at a temperature≤30.0° C. of ≥5.0 wt.-% and ≤15.0 wt.-%, preferably ≥7.5 wt.-% and ≤12.5 wt.-%, with regard to the total weight of the polyethylene; and two distinct peaks in the a-TREF curve in the elution temperature range of between 50.0 and 90.0° C., wherein the elution temperature gap between the two peaks is ≤17.5° C., preferably ≤ 15.0° C.

Starting therefrom, it is one objective of the present invention to provide a multilayered film which is not only easy to recycle but has also good balance of mechanical and sealing properties.

This objective has been solved by the multilayered film according to claim 1 comprising a skin layer (SKL), a core layer (CL) and a sealing layer (SL); wherein the core layer (CL) comprises
(a) 5 to 40 wt.-% based on the total weight of the core layer (CL) of a metallocene-catalysed multimodal polyethylene copolymer (MMCP) having
   a density (ASTM D792) in the range of 880 to 925 kg/m³;
   a MFR2 (190° C., 2.16 kg, ISO 1133) in the range of 0.1 to 6.0 g/10 min; and
   a ratio of the MFR21 (190° C., 21.6 kg, ISO 1133) to MFR2 (190° C., 2.16 kg, ISO 1133), MFR21/MFR2, in the range of 22 to 70; and
(b) 60 to 95 wt.-% based on the total weight of the core layer (CL) of a multimodal Ziegler-Natta catalysed linear low density polyethylene (ZNCP) having
   a density (ASTM D792) in the range of 925 to 950 kg/m³; and
   a MFR5 (190° C., 5 kg, ISO 1133) in the range of 0.1 to 6.0 g/10 min; wherein components (a) and (b) add up to 100 wt.-%.

Advantageous embodiments of the multilayered film in accordance with the present invention are specified in the dependent claims 2 to 14. The present invention further relates in accordance with claim 15 to the use of the article according to the present invention as packaging material.

### Definitions

A metallocene-catalysed (linear low density) polyethylene is defined in this invention as a (linear low density) polyethylene copolymer, which has been produced in the presence of a metallocene catalyst.

A Ziegler-Natta-catalysed (linear low density) polyethylene is defined in this invention as a linear low density polyethylene copolymer, which has been produced in the presence of a Ziegler-Natta catalyst.

For the purpose of the present invention the metallocene-catalysed (linear low density) polyethylene may consist of an ethylene-1-butene polymer component (A) and an ethylene-1-hexene polymer component (B) which means that the polymer is produced in an at least 2-stage sequential polymerization process, wherein first component (A) is produced and component (B) is then produced in the presence of component (A) in a subsequent polymerization step, yielding the metallocene-catalysed (linear low) density polyethylene or vice versa, i.e. first component (B) is produced and component (A) is then produced in the presence of component (B) in a subsequent polymerization step, yielding the metallocene-catalysed (linear low density) polyethylene.

The term “multimodal” in context of multimodal metallocene-catalysed (linear low density) polyethylene or Ziegler-Natta-catalysed (linear low density) polyethylene means herein multimodality with respect to melt flow rate (MFR) of at least the ethylene polymer components (A) and (B), i.e. the ethylene polymer components (A) and (B), have different MFR values. The multimodal metallocene-catalysed (linear low density) polyethylene can have further multimodality between the ethylene polymer components (A) and (B) with respect to one or more further properties, like density, comonomer type and/or comonomer content, as will be described later below.

A homopolymer in the context of the present invention may comprise up to 3.0 mol-% based on the total weight of the homopolymer of comonomers, preferably up to 2.0 mol-% but may be also free of copolymers.

A mono-material film in the context of the present invention may be a film using mainly one kind of polymer for example polyethylene, but no other polymers in significant amounts. However, in case the film is polyethylene-based different polyethylenes may be present.

Low density polyethylene (LDPE) is defined in this invention as low density polyethylene copolymer, which has been preferably produced in a high-pressure process.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Metallocene-Catalysed Multimodal Polyethylene Copolymer (MMCP)

The core layer (CL) of the multilayered film according to the present invention comprises 5 to 40 wt.-% based on the total weight of the core layer (CL) of a specific metallocene-catalysed multimodal polyethylene copolymer (MMCP). The other layers may also comprise said copolymer (MMCP).

The multimodal polyethylene copolymer (MMCP) has a density (ASTM D792) in the range of 880 to 925 kg/m³, a MFR2 (190° C., 2.16 kg, ISO 1133) in the range of 0.1 to 6.0 g/10 min and a ratio of the MFR21 (190° C., 21.6 kg, ISO 1133) to MFR2 (190° C., 2.16 kg, ISO 1133), MFR21/MFR2, in the range of 22 to 70.

According to one preferred embodiment in accordance with the present invention the metallocene-catalysed multimodal polyethylene copolymer (MMCP) consists of an ethylene polymer component (A), preferably being a copolymer of ethylene with 1-butene, which more preferably consists of an ethylene polymer fraction (A-1) and an ethylene polymer fraction (A-2); and an ethylene polymer component (B), preferably being a copolymer of ethylene and 1-hexene.

In a preferred embodiment of the present invention, the ethylene-1-butene polymer component (A) consists of an ethylene polymer fraction (A-1) and (A-2).

In case that the ethylene-1-butene polymer component (A) consists of ethylene polymer fractions (A-1) and (A-2), the MFR2 of the ethylene polymer fractions (A-1) and (A-2) may be the same or different from each other.

According to another preferred embodiment of the present invention the metallocene-catalysed multimodal polyethylene copolymer (MMCP) has a MFR2 (190° C., 2.16 kg, ISO 1133) of the ethylene polymer fraction (A-1) in the range of 1.0 to 15.0 g/10 min or 100 to 140 g/10 min, preferably of 1.5 to 13.0 g/10 min or 110 to 130 g/10 min, more preferably of 2.0 to 11.0 g/10 min or 115 to 125 g/10 min and even more preferably of 2.5 to 10.5 g/10 min or 117 to 124 g/10 min.

Still another preferred embodiment of the present invention stipulates that the metallocene-catalysed multimodal polyethylene copolymer (MMCP) has a MFR2 (190° C., 2.16 kg, ISO 1133) of the ethylene polymer fraction (A-2) in the range of 2.0 to 30.0 g/10 min or 100 to 140 g/10 min, preferably of 2.5 to 20.0 g/10 min or 110 to 130 g/10 min and more preferably of 3.0 to 15.0 g/10 min or 115 to 125 g/10 min.

According to another preferred embodiment of the present invention the metallocene-catalysed multimodal polyethylene copolymer (MMCP) has a MFR2 (190° C., 2.16 kg, ISO 1133) of ethylene polymer component (A) in the range of 2.0 to 30.0 g/10 min or 100 to 140 g/10 min, preferably of 2.5 to 20.0 g/10 min or 110 to 130 g/10 min, more preferably of 3.0 to 15.0 g/10 min or 115 to 128 g/10 min and even more preferably of 3.2 to 10.0 g/10 min or 120 to 125 g/10 min.

A further preferred embodiment of the present invention stipulates that the metallocene-30 catalysed multimodal polyethylene copolymer (MMCP) has a MFR2 (190° C., 2.16 kg, ISO 1133) of ethylene polymer component (B) in the range of 0.01 to 1.5 g/10 min or 0.001 to 1.5 g/10 min, preferably of 0.05 to 1.2 g/10 min, more preferably of 0.1 to 1.0 g/10 min and even more preferably of 0.2 to 0.7 g/10 min.

35 In a preferred embodiment the MFR2 of the ethylene polymer components (A) and (B) are different from each other.

According to another preferred embodiment in accordance with the present invention the MFR2 (190° C., 2.16 kg, ISO 1133) of the multimodal copolymer (MMCP) is in the range of 0.1 to 2.0 g/10 min, preferably 0.2 to 1.7 g/10 min, more preferably 0.5 to 1.0 g/10 min.

According to another preferred embodiment of the present invention the metallocene-catalysed multimodal polyethylene copolymer (MMCP) has a ratio of the MFR2 (190° C., 2.16 kg, ISO 1133) of ethylene polymer component (A) to the MFR2 (190° C., 2.16 kg, ISO 1133) of MMCP in the range of 2.5 to 20.0, preferably of 3.0 to 15.0 and more preferably of 3.5 to 10.0.

In another preferred embodiment according to the present invention the metallocene-catalysed multimodal polyethylene copolymer (MMCP) has a density (ASTM D792) of the ethylene polymer component (A) in the range of 920 to 950 kg/m³, preferably of 925 to 950 kg/m³, more preferably of 930 to 945 kg/m³.

A further preferred embodiment of the present invention stipulates that the metallocene-catalysed multimodal polyethylene copolymer (MMCP) has a density (ASTM D792) of the ethylene polymer component (B) in the range of 880 to 915 kg/m³, preferably of 885 to 910 kg/m³, and more preferably of 890 to 905 kg/m³.

According to another preferred embodiment of the present invention the metallocene-catalysed multimodal polyethylene copolymer (MMCP) has a density (ASTM D792) of the polymer fraction (A-1) in the range of 920 to 960 kg/m³, preferably of 925 to 955 kg/m³, more preferably of 930 to 950 kg/m³.

According to still a further preferred embodiment of the present invention the metallocene-catalysed multimodal polyethylene copolymer (MMCP) has a density (ASTM D792) of the polymer fraction (A-2) in the range of 930 to 950 kg/m³, preferably of 935 to 945 kg/m³.

In another preferred embodiment the metallocene-catalysed multimodal polyethylene copolymer (MMCP) has a density (ASTM D792) in the range of 900 to 925 kg/m³ and preferably of 910 to 925 kg/m³.

Naturally, in addition to multimodality with respect to, i.e. difference between, the MFR2 of ethylene polymer components (A) and (B), the multimodal PE of the invention can also be multimodal e.g. with respect to one or both of the two further properties: multimodality with respect to, i.e. difference between, the comonomer content(s) present in the ethylene polymer components (A) and (B); and/or the density of the ethylene polymer components (A) and (B).

Preferably, the multimodal copolymer (MMCP) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in a so called multistage process, then the comonomer content of the first produced component, e.g. component (A), can be measured and the comonomer content of the other component, e.g. component (B), can be calculated according to following equation:

Comonomer content (wt.-% or mol-%) in component B=(comonomer content (wt.-% or mol-%) in final product−(weight fraction of component A* comonomer content (wt.-% or mol-%) in component A))/(weight fraction of component B).

Another preferred embodiment of the present stipulates that the total amount of 1-butene based on the MMCP is in the range of 0.1 to 1.5 wt.-%, preferably of 0.2 to 1.3 wt.-% and more preferably of 0.4 to 1.2 wt.-% or 0.4 to 0.6 wt.-% and/or the total amount of 1-hexene based on the MMCP is in the range of 2.0 to 20.0 wt.-%, more preferably 4.0 to 18.0 wt.-% and still more preferably 6.0 to 15.0 wt.-%.

According to another preferred embodiment of the present invention the metallocene-catalysed multimodal polyethylene copolymer (MMCP) consists of (i) 35.0 to 50.0 wt.-% of an ethylene-1-butene polymer component (A), and (ii) 50.0 to 65.0 wt.-% of an ethylene-1-hexene polymer component (B).

A further preferred embodiment of the present invention stipulates that the metallocene-catalysed multimodal polyethylene copolymer (MMCP) has a total amount of 1-butene in the ethylene polymer component (A) in the range of 0.5 to 5.0 wt.-%, preferably of 0.6 to 4.0 wt.-%, more preferably of 0.8 to 3.0 wt.-% and even more preferably of 1.0 to 2.0 wt.-%, based on the total weight of the ethylene polymer component (A).

In another preferred embodiment in accordance with the present invention that the metallocene-catalysed multimodal polyethylene copolymer (MMCP) has a total amount of 1-hexene in the ethylene polymer component (B) in the range of 3.0 to 25.0 wt.-%, preferably of 4.0 to 22.0 wt.-% and more preferably of 10 to 20.0 wt.-%, based on the total weight of ethylene polymer component (B).

The multimodal copolymer (MMCP) preferably has a ratio of the MFR21 (190° C., 21.6 kg, ISO 1133) to MFR2 (190° C., 2.16 kg, ISO 1133), MFR21/MFR2, in the range of from 22 to 60, preferably from 23 to 50, more preferably from 25 to 48 and still more preferably from 28 to 45.

The metallocene catalysed multimodal copolymer (MMCP) is preferably a (linear low density) polyethylene (LLDPE) which has a well-known meaning.

More preferably the multimodal copolymer (MMCP) is multimodal at least with respect to, i.e. has a difference between, the MFR2, the comonomer content as well as with respect to, i.e. has a difference between the density of the ethylene polymer components, (A) and (B), as defined above, below or in the claims including any of the preferable ranges or embodiments of the polymer composition.

The multimodal copolymer (MMCP) furthermore may have a molecular weight distribution (Mw/Mn) determined with GPC in the range of at least 3.5 up to 7.2, preferably in the range of 4.0 to 7.0 and more preferably in the range of 4.5 to 6.8.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 35.0 to 50.0 wt.-% based on the multimodal copolymer (MMCP), preferably in an amount of 36.0 to 48.0 wt.-% and even more preferably in an amount of 38.0 to 45.0 wt.-%.

Thus, the ethylene polymer component (B) is present in an amount of 50.0 to 65.0 wt.-% based on the multimodal copolymer (MMCP), preferably in an amount of 52.0 to 64.0 wt.-% and more preferably in an amount of 55.0 to 62.0 wt.-%.

The metallocene-catalysed multimodal copolymer (MMCP), can be produced in a 2-stage process, preferably comprising a slurry reactor (loop reactor), whereby the slurry (loop) reactor is connected in series to a gas phase reactor (GPR), whereby the ethylene polymer component (A) is produced in the loop reactor and the ethylene polymer component (B) is produced in GPR in the presence of the ethylene polymer component (A) to produce the multimodal copolymer (MMCP).

In case that the ethylene component (A) of the multimodal copolymer (MMCP) consists of ethylene polymer fractions (A-1) and (A-2), the multimodal copolymer (MMCP) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273 A1, WO 2021/009189 A1, WO 2021/009190 A1, WO 2021/009191 A1 and WO 2021/009192 A1. Full details of how to prepare suitable metallocene-catalysed multimodal copolymer (MMCP) can be found in these references.

The metallocene-catalysed multimodal copolymer (MMCP) is produced by using a metallocene catalyst. The metallocene catalyst preferably comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

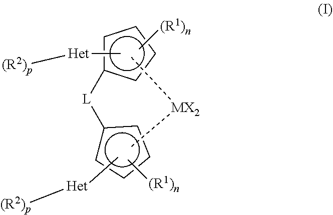

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

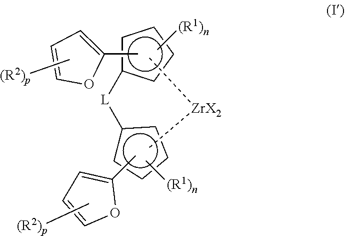

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

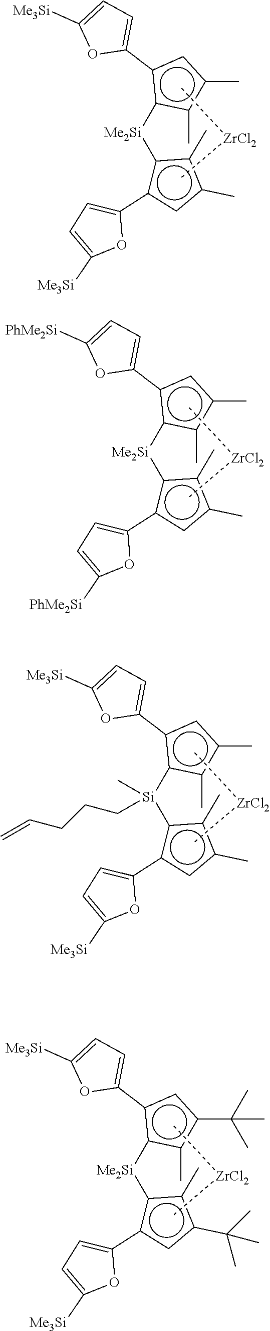

Most preferably the complex dimethylsilanediylbis [2-(5-trimethylsilylfuran-2-yl)-4,5-dimethylcyclopentadien-1-yl]zirconium dichloride is used.

More preferably the ethylene polymer components (A) and (B) of the multimodal copolymer (MMCP) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

### Ziegler-Natta Catalysed Linear Low Density Polyethylene (ZNCP)

The core layer (CL) of the multilayered film according to the present invention comprises 60 to 95 wt.-% based on the total weight of the core layer (CL) of a specific multimodal Ziegler-Natta catalysed linear low density polyethylene (ZNCP). The other layers may also comprise said copolymer (ZNCP).

The multimodal Ziegler-Natta catalysed linear low density polyethylene (ZNCP) has a density (ASTM D792) in the range of 925 to 950 kg/m³; and a MFR5 (190° C., 5 kg, ISO 1133) in the range of 0.1 to 6.0 g/10 min.

According to a preferred embodiment the multimodal Ziegler-Natta catalysed linear low density polyethylene (ZNCP) has a density (ASTM D792) in the range from 920 to 950 kg/m³, more preferably from 927 to 947 kg/m³, even more preferably in the range from 930 to 945 kg/m³ and most preferably in the range from 930 to 943 kg/m³.

According to one preferred embodiment in accordance with the present invention the multimodal Ziegler-Natta catalysed linear low density polyethylene (ZNCP) comprises (C) a lower molecular weight (LMW) homopolymer of ethylene; and (D) a higher molecular weight (HMW) terpolymer of ethylene, 1-butene and 1-hexene. The LMW homopolymer fraction (C) has a lower molecular weight than the HMW terpolymer fraction (D).

The lower molecular weight fraction (C) of the ZNCP has a MFR2 (190° C., 2.16 kg, ISO 1133) in the range of 200 to 1000 g/10 min and preferably of 250 to 800 g/10 min, a density (ASTM D792) the range of 940 to 980 kg/m³ and preferably 945 to 975 kg/m³ and a comonomer content in the range of 0 to 2.5 mol-% and preferably of 0 to 2.0 mol-%.

The higher molecular weight fraction (D) has a lower MFR2 and a lower density than the lower molecular weight fraction (C).

Another preferred embodiment in accordance with the present invention stipulates that the lower molecular weight (LMW) homopolymer of ethylene (C) consists of two homopolymer fractions (C-1) and (C-2) wherein the homopolymer fraction (C-1) preferably has a MFR2 (190° C., 2.16 kg, ISO 1133) in the range of 100 to 400 g/10 min and more preferably in the range of 150 to 300 g/10 min and/or the homopolymer fraction (C-2) preferably has a MFR2 (190° C., 2.16 kg, ISO 1133) in the range of 450 to 1200 g/10 min and more preferably in the range of 600 to 1100 g/10 min and/or the MFR2 of fraction (C-1) is preferably lower than the MFR2 of the total lower molecular weight (LMW) homopolymer of ethylene (C) and/or the density of the two homopolymer fractions (C-1) and (C-2) may be the same or may be different and is in the range of 955 to 980 kg/m³, preferably 965 to 980 kg/m³ or 965 to 975 kg/m³.

According to another preferred embodiment the MFR5 (ISO1133) of the multimodal Ziegler-Natta catalysed linear low density polyethylene (ZNCP) is in the range from 0.05 to 6.0 g/10 min, more preferably in the range from 0.1 to 10 g/10 min and even more preferably in the range from 0.2 to 6.0 g/10 min. The MFR5 (ISO 1133) is highly preferably in the range from 0.3 to 5.0 g/10 min or 0.3 to 3.0 g/10 min.

In another preferred embodiment of the present invention the MFR21 of the multimodal Ziegler-Natta catalysed linear low density polyethylene (ZNCP) is in the range from 5.0 to 200 g/10 min, preferably in the range from 10.0 to 200 g/10 min, more preferably in the range from 10.0 to 100 g/10 min, even more preferably in the range from 15.0 to 50.0 g/10 min and most preferably in the range from 15.0 to 45.0 g/10 min.

The Mw of the multimodal Ziegler-Natta catalysed linear low density polyethylene (ZNCP) may be in the range from 80,000 to 300,000, preferably in the range from 100,000 to 270,000 and more preferably in the range from 120,000 to 160,000.

The multimodal Ziegler-Natta catalysed linear low density polyethylene (ZNCP) is produced in the presence of a Ziegler Natta olefin polymerization catalyst. Ziegler Natta catalysts are useful as they can produce polymers within a wide range of molecular weight and other desired properties with a high productivity. Ziegler Natta catalysts used in the present invention are preferably supported on an external support.

Suitable Ziegler Natta catalysts preferably contain a magnesium compound, an aluminium compound and a titanium compound supported on a particulate support. The particulate support typically used in Ziegler-Natta catalysts comprises an inorganic oxide support, such as silica, alumina, titania, silica-alumina and silica-titania or a MgCl₂ based support.

The transition metal is preferably titanium. The titanium compound is a halogen containing titanium compound, preferably chlorine containing titanium compound. Especially preferred titanium compound is titanium tetrachloride.

The catalyst can be prepared by sequentially contacting the carrier with the above mentioned compounds, as described in EP 0 688 794 A1 or WO 99/51646 A1. Alternatively, it can be prepared by first preparing a solution from the components and then contacting the solution with a carrier, as described in WO 01/55230 A1.

The Ziegler Natta catalyst is used together with an activator, which is also called cocatalyst. Suitable activators are metal alkyl compounds, typically Group 13 metal alkyl compounds, and especially aluminium alkyl compounds. They include trialkylaluminium compounds, such as trimethylaluminium, triethylaluminium, tri-isobutylaluminium, trihexylaluminium and tri-n-octylaluminium. Aluminium alkyl compounds may also include alkyl aluminium halides, such as ethylaluminium dichloride, diethylaluminium chloride, ethylaluminium sesquichloride, dimethylaluminium chloride and the like and alkylaluminium oxy-compounds, such as methylaluminiumoxane, hexaisobutylaluminiumoxane and tetraisobutylaluminiumoxane and also other aluminium alkyl compounds, such as isoprenylaluminium. Especially preferred cocatalysts are trialkylaluminiums, of which triethylaluminium, trimethylaluminium and tri-isobutylaluminium are particularly preferred.

The amount in which the activator is used depends on the specific catalyst and activator. Typically triethylaluminium is used in such amount that the molar ratio of aluminium to the transition metal, like Al/Ti, is for example from 1 to 1000, preferably from 3 to 100 and in particular from about 5 to about 30 mol/mol.

The multimodal Ziegler-Natta catalysed linear low density polyethylene (ZNCP) may be produced by polymerization using conditions which create a multimodal (e.g. bimodal) polymer. Typically, a two or more stage, i.e. multistage, polymerization process is used with different process conditions in the different stages or zones (e.g. different temperatures, pressures, polymerization media, hydrogen partial pressures, etc.). Preferably, the multimodal (e.g. bimodal) polymer is produced by a multistage polymerization, e.g. using a series of reactors, with optional comonomer addition preferably in only the reactor(s) used for production of the higher/highest molecular weight component(s). A multistage process is defined to be a polymerization process in which a polymer comprising two or more fractions is produced by producing each or at least two polymer fraction(s) in a separate reaction stage, usually with different reaction conditions in each stage, in the presence of the reaction product of the previous stage which comprises a polymerization catalyst. The polymerization reactions used in each stage may involve conventional ethylene homopolymerization or copolymerization reactions, e.g. gas-phase, slurry phase, liquid phase polymerizations, using conventional reactors, e.g. loop reactors, gas phase reactors, batch reactors etc. (see for example WO97/44371 A1 and WO96/18662 A1. Polymers meeting the requirements of the invention are known and can be bought from suppliers such as Borealis and Borouge, e.g. FX1001.

### Multilayered Film

A preferred embodiment of the multilayered film in accordance with the present invention stipulates that the core layer (CL) comprises and preferably consists of (a) 10 to 25 wt.-% and preferably 18 to 22 wt.-% based on the total weight of the core layer (CL) of the metallocene-catalysed multimodal polyethylene copolymer (MMCP) and (b) 75 to 90 wt.-% and preferably 78 to 82 wt.-% based on the total weight of the core layer (CL) of a multimodal Ziegler-Natta catalysed linear low density polyethylene (ZNCP); wherein components (a) and (b) add up to 100 wt.-%.

Still another preferred embodiment in accordance with the present invention stipulates that the multilayer film consists of the skin layer (SKL), the core layer (CL) and the sealing layer (SL). It is self-explanatory that the core layer (CL) is placed between the skin layer (SKL) and the sealing layer (SL).

According to a further preferred embodiment according to the present invention the skin layer (SKL) comprises and preferably consists of 80 to 95 wt.-%, more preferably 82 to 93 wt.-% and still more preferably 88 to 92 wt.-% based on the total weight of the skin layer (SKL) of the metallocene-catalysed multimodal polyethylene copolymer (MMCP) and 5 to 20 wt.-%, preferably 7 to 18 wt.-%, more preferably 8 to 12 wt.-% based on the total weight of the skin layer (SKL) of a LDPE having a density (ASTM D792) in the range of 920 to 940 kg/m³, preferably of 930 to 936 kg/m³ and a MFR2 (190° C., 2.16 kg, ISO 1133) in the range of 0.5 to 4.0 g/10 min and preferably of 0.1 to 1.0 g/10 min.

Another preferred embodiment of the multilayered film in accordance with the present invention stipulates that the sealing layer (SL) comprises and preferably consists of 90 to 100 wt.-%, preferably 95 to 100 wt.-% based on the total weight of the sealing layer (SL) of the metallocene-catalysed multimodal polyethylene copolymer (MMCP), or 50 to 70 wt.-%, preferably 55 to 65 wt.-% based on the total weight of the sealing layer (SL) of a plastomer, being preferably a copolymer of ethylene and 1-octene, preferably having a density (ASTM D792) in the range of 860 to 910 kg/m³, preferably of 895 to 905 kg/m³ and a MFR2 (190° C., 2.16 kg, ISO 1133) in the range of 0.5 to 10.0 g/10 min, preferably of 1.0 to 1.5 g/10 min; and 30 to 50 wt.-%, preferably 35 to 45 wt.-% based on the total weight of the sealing layer (SL) of a multimodal metallocene catalysed linear low density polyethylene being preferably a bimodal ethylene/1-butene/1-hexene terpolymer, preferably having a density (ASTM D792) in the range of 910 to 930 kg/m³, more preferably of 916 to 925 kg/m³; and a MFR2 (190° C., 2.16 kg, ISO 1133) in the range of 0.5 to 2.0 g/10 min.

The polymers used in the multilayered film according to the present invention may contain additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in form of a so-called master batch, which comprises the respective additive(s) together with a carrier polymer. In such case the carrier polymer is not calculated to the polymer components of the metallocene-catalysed multimodal polyethylene copolymer (MMCP), but to the amount of the respective additive(s), based on the total amount of polymer composition (100 wt.-%).

According to a further preferred embodiment according to the present invention the skin layer (SKL) of the multilayered film has a thickness in the range of 1 to 100 μm, preferably in the range of 5 to 80 μm and more preferably in the range of 10 to 15 μm.

Still another preferred embodiment in accordance with the present invention stipulates that the core layer (CL) of the multilayered film has a thickness in the range of 10 to 200 μm, preferably in the range of 20 to 80 μm and more preferably in the range of 30 to 45 μm.

In another preferred embodiment of the multilayered film in accordance with the present invention the sealing layer (SL) of the multilayered film has a thickness in the range of 1 to 50 μm, preferably in the range of 5 to 25 μm and more preferably in the range of 10 to 15 μm.

According to a further preferred embodiment according to the present invention the multilayered film has a thickness in the range of 12 to 350 μm, preferably in the range of 40 to 150 μm and more preferably in the range of 50 to 90 μm.

Still another preferred embodiment in accordance with the present invention stipulates that the multilayered film has a Tensile Modulus in MD (ISO 527-3) in the range of 200 to 500 MPa, preferably in the range of 280 to 400 MPa.

In another preferred embodiment of the multilayered film in accordance with the present invention the multilayered film has a Tensile Modulus in TD (ISO 527-3) in the range of 250 to 600 MPa, preferably in the range of 340 to 500 MPa.

According to a further preferred embodiment according to the present invention the multilayered film has a Dart Drop Strength (ISO 7765-1) in the range of 500 to 1000 g, preferably in the range of 800 to 950 g.

In another preferred embodiment of the multi-layered film in accordance with the present invention the multilayered film has a Sealing Initiation Temperature determined as described in the specification in the range of 60 to 85° C. and preferably in the range of 63 to 68° C.

Still another preferred embodiment in accordance with the present invention stipulates that the multilayered film consists of polyethylene-based polymers.

### Method

Another aspect of the present invention relates to a method for producing the multilayered film.

The multilayered film according to the present invention is generally prepared by a conventional process, wherein the layers of the film are coextruded.

The different polymer components in any of the layers of the film are typically intimately mixed prior to layer formation, for example using a twin screw extruder, preferably a counter-rotating extruder or a co-rotating extruder. Then, the blends are converted into a coextruded film.

Generally, the multilayered film according to the present invention can be produced by a blown film or cast film process, preferably by a blown film process.

In order to manufacture such films, for example at least three polymer melt streams are simultaneously extruded (i.e. coextruded) through a multi-channel tubular, annular or circular die to form a tube which is blown-up, inflated and/or cooled with air (or a combination of gases) to form a film. The manufacture of blown film is a well-known process.

The blown (co-) extrusion can be effected at a temperature in the range 150 to 230° C., more preferably 160 to 225° C. and cooled by blowing gas (generally air) at a temperature of 10 to 40° C., more preferably 12 to 16° C. to provide a frost line height of 0.5 to 4 times, more preferably 1 to 2 times the diameter of the die.

The blow up ratio (BUR) should generally be in the range of 1.5 to 3.5, preferably 2.0 to 3.0, more preferably 2.1 to 2.8.

### Use

A further aspect of the present invention refers to the use of the multilayered film as packaging material, preferably for food and/or medical products.

The invention will now be described with reference to the following non-limiting examples.

### Experimental Part

### A. Measuring Methods

The following definitions of terms and determination methods apply for the above general description of the invention as well as to the below examples unless otherwise defined.

### Melt Flow Rate

The melt flow rate (MFR) was determined according to ISO 1133-Determination of the melt mass-flow rate (MFR) and melt volume-flow rate (MVR) of thermoplastics—Part 1: Standard method and is indicated in g/10 min. The MFR is an indication of the flowability, and hence the processability, of the polymer. The higher the melt flow rate, the lower the viscosity of the polymer. The MFR of polyethylene is determined at a temperature of 190° C. and may be determined at different loadings such as 2.16 kg (MFR₂), 5 kg (MFR₅) or 21.6 kg (MFR₂₁).

### Calculation of MFR₂ of Component B and of Fraction (A-2)

$$log A = x \cdot log B + ( 1 - x ) \cdot log C$$

$$C = 10 {\hat{}}^{\frac{( log A - x . log B}{( 1 - x )}}$$

### For Component B:

B=MFR₂ of Component (A)
C=MFR₂ of Component (B)
A=final MFR₂ (mixture) of multimodal polyethylene copolymer (P)
X=weight fraction of Component (A)

### For Fraction (A-2):

B=MFR₂ of 1st fraction (A-1)
C=MFR₂ of 2nd fraction (A-2)
A=final MFR₂ (mixture) of loop polymer (=Component (A))
X=weight fraction of the 1st fraction (A-1).

### Density

Density of the polymer was measured according to ASTM; D792, Method B (density by balance at 23° C.) on compression moulded specimen prepared according to EN ISO 1872-2 and is given in kg/m³.

### DSC Analysis, Melting (Tm) and Crystallization Temperature (Tc)

Data may be measured with a TA Instrument Q2000 differential scanning calorimetry (DSC) on 5 to 7 mg samples. DSC was run according to ISO 11357/part 3/method C₂ in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) are determined from the second heating step.

### Dart Drop Strength (DDI): Impact Resistance by Free-Falling Dart Method

The DDI was measured according to ISO 7765-1:1988/Method A from the films as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure weight-50% [g].

### Tensile Modulus™

Tensile modulus (MPa) was measured in machine (MD) and transverse direction (TD) according to ISO 527-3 on film samples prepared as described below with a film thickness of 60 μm and at a cross head speed of 1 mm/min.

### Sealing Initiation Temperature (SIT); Sealing End Temperature (SET), Sealing Range

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, delay time and clamp separation rate have been modified. The determination of the force/temperature curve was continued until thermal failure of the film.

The sealing range was determined on a J&B Universal Sealing Machine Type 4000 with the films as produced indicated below blown film of 60 μm thickness with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/see

Comonomer contents-Quantification of microstructure by NMR spectroscopy Quantitative nuclear-magnetic resonance (NMR) spectroscopy was used to quantify the comonomer content of the polymers.

Quantitative ¹³C {¹H} NMR spectra were recorded in the molten-state using a Bruker Avance III 500 NMR spectrometer operating at 500.13 and 125.76 MHz for ¹H and ¹³C respectively. All spectra were recorded using a ¹³C optimized 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed

Sens: By Coni utilizing the NOE at short recycle delays of 3 s {pollard04, klimke06} and the RS-HEPT decoupling scheme {fillip05,griffin07}. A total of 1024 (1k) transients were acquired per spectra.

Quantitative ¹³C {¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = Btotal / ( Etotal + Btotal + Htotal )$$

The amount isolated 1-butene incorporated in EEBEE sequences was quantified using the integral of the _{*}B2 sites at 39.8 ppm accounting for the number of reporting sites per comonomer:

$$B = {I}_{* B 2}$$

If present the amount consecutively incorporated 1-butene in EEBBEE sequences was quantified using the integral of the _{∝∝}B2B2 site at 39.4 ppm accounting for the number of reporting sites per comonomer:

$$BB = 2 * I αα B 2 B 2$$

If present the amount non-of reporting sites per comonomer:

$$HEH = 2 * I ββ B 4 B 4$$

Sequences of HHH were not observed. The total 1-hexene content was calculated based on the sum of isolated, consecutive and non consecutively incorporated 1-hexene:

$$Htotal = H + H H + H E H$$

The total mole fraction of 1-hexene in the polymer was then calculated as:

$$fH = Htotal / ( Etotal + Btotal + Htotal )$$

The mole percent comonomer incorporation is calculated from the mole fraction:

$$\begin{matrix}B [ mol \% ] = 100 * fB \\ H [ mol \% ] = 100 * fH\end{matrix}$$

The weight percent comonomer incorporation is calculated from the mole fraction:

$$\begin{matrix}B [ wt \% ] = 100 * ( fB * 56.11 ) / ( ( fB * 56.11 ) + ( fH * 84.16 ) + ( ( 1 - ( f B + f H ) ) * 28. 05 ) ) \\ H [ wt \% ] = 100 * ( fH * 84.16 ) / ( ( fB * 56.11 ) + ( fH * 84.16 ) + ( ( 1 - ( f B + f H ) ) * 28. 05 ) )\end{matrix}$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239.
Griffin, J. M., Tripon, C., Samoson, A., Filip, C., and Brown, S. P., Mag. Res. in Chem. 2007 45, S1, S198.
Castignolles, P., Graf, R., Parkinson, M., Wilhelm, M., Gaborieau, M., Polymer 50 (2009) 2373.
Busico, V., Cipullo, R., Prog. Polym. Sci. 26 (2001) 443.
Busico, V., Cipullo, R., Monaco, G., Vacatello, M., Segre, A. L., Macromoleucles 30 (1997) 6251.
Zhou, Z., Kuemmerle, R., Qiu, X., Redwine, D., Cong, R., Taha, A., Baugh, D. Winniford, B., J. Mag. Reson. 187 (2007) 225.
Busico, V., Carbonniere, P., Cipullo, R., Pellecchia, R., Severn, J., Talarico, G., Macromol. Rapid Commun. 2007, 28, 1128.
Resconi, L., Cavallo, L., Fait, A., Piemontesi, F., Chem. Rev. 2000, 100, 1253.

### B. Materials Used

FT5236 is a low density polyethylene (MFR₂ (190° C./2.16 kg): 0.75 g/10 min, density: 923 kg/m³, Tₘ 112° C., produced by Tubular Technology) commercially available as FT5236 from Borealis AG and contains anti-block, antioxidant and slip additives.

FK1820 is a bimodal ethylene/1-butene/1-hexene terpolymer (MFR₂ (190° C./2.16 kg): 1.5 g/10 min, density: 918.0 kg/m³, Tₘ 122° C., produced with a metallocene catalyst) commercially available as Anteo™ FK1820 from Borouge and contains antioxidant and processing aid.

FX1001 is a multimodal alpha-olefin terpolymer (MFR₅ (190° C./5 kg): 0.9 g/10 min, MFR₂₁ (190° C./21 kg: 20.0 g/10 min, density: 931 kg/m³, Tₘ 127° C., C4-content 2.2 wt.-% and C6-content 4.0 wt.-% based on the weight of the total polymer, produced with a Ziegler-Natta catalyst, ZNCP) commercially available as BorShape™ FX1001 from Borealis AG and contains antioxidant.

Queo 0201 is an unimodal ethylene based 1-octene plastomer (MFR₂ (190° C./2.16 kg): 1.1 g/10 min, density: 902 kg/m³, Tₘ 97° C., produced in a solution polymerization process using a metallocene catalyst) commercially available as Queo™ 0201 from Borealis AG and contains processing stabilizers.

ZNCP is a multimodal alpha-olefin terpolymer (MFR₅ (190° C./5 kg): 1.5 g/10 min, MFR₂₁ (190° C./21 kg: 32.0 g/10 min, density: 941 kg/m³, Tₘ 128° C., C4-content 0.9 wt.-% and C6-content 3.1 wt.-% based on the weight of the total polymer density, produced with a Ziegler-Natta catalyst) and was produced as follows.

The polymerization was carried out in a Borstar pilot plant with a 3-reactor set-up (loop 1-loop 2-GPR) and a prepolymerization loop reactor according to the conditions as given in Table 1. A solid polymerization catalyst component produced as described in Example 1 of EP 1 378 528 A1 was introduced into the reactor together with triethylaluminium cocatalyst so that the molar ratio of Al/Ti was about 15.

TABLE 1
Polymerization conditions:

| Prepoly. reactor | |
|---|---|
| Temperature (° C.) | 70 |
| Pressure (kPa) | 5783 |
| Split (wt.-%) | 2 |
| First loop reactor | |
| Temperature (° C.) | 95 |
| Pressure (kPa) | 5512 |
| C2 (mol-%) | 4.7 |
| H2/C2 (mol/kmol) | 306 |
| MFR2 (g/10 min) | 195 |
| Split (wt.-%) | 18 |
| Second loop reactor | |
| Temperature (° C.) | 95 |
| Pressure (kPa) | 5382 |
| C2 (mol-%) | 5.5 |
| H2/C2 (mol/kmol) | 563 |
| Split(wt.-%) | 26 |
| MFR₂ (g/10 min) | 390 |
| Gas phase reactor | |
| Temperature (° C.) | 82 |
| Pressure (kPa) | 1988 |
| C2 (mol-%) | 13.1 |
| H2/C2 (mol/kmol) | 22.0 |
| C4/C2 (mol/kmol) | 94.4 |
| C6/C2 (mol/kmol) | 123.5 |
| Split (wt.-%) | 54 |

The polymer powder was mixed under nitrogen atmosphere with 1200 ppm of Irganox B561 (commercially available from BASF SE) and 400 ppm Ca-stearate. Then it was compounded and extruded under nitrogen atmosphere to pellets by using a JSW CIMP90 twin screw extruder.

MMCP1, MMCP2 and MMCP3 are multimodal copolymers and were prepared as follows: Catalyst preparation (CAT)

### Loading of SiO2:

10 kg of silica (PQ Corporation ES757, calcined 600° C.) was added from a feeding drum and inertized in a reactor until O₂ level below 2 ppm was reached.

### Preparation of MAO/Tol/MC:

30 wt.-% MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 minutes. Metallocene Rac-dimethylsilanediylbis {2-(5-(trimethylsilyl) furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during MAO/tol/MC addition. MAO/tol/MC solution (22.2 kg) was added within 205 minutes followed by 60 minutes stirring time (oil circulation temp was set to 25° C.). After stirring “dry mixture” was stabilised for 12 hours at 25° C. (oil circulation temp), stirring 0 rpm. Reactor was turned 20° (back and forth) and stirring was turned on 5 rpm for few rounds once an hour. After stabilisation the catalyst was dried at 60° C. (oil circulation temp) for 2 hours under nitrogen flow 2 kg/h, followed by 13 hours under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Polymerization:

The polymerization was carried out in a Borstar pilot plant with a 3-reactor set-up (loop 1-loop 2-GPR) and a prepolymerization loop reactor according to the conditions as given in Table 2.

TABLE 2
Polymerization conditions.

| | MMCP1 | MMCP2 | MMCP3 |
|---|---|---|---|
| Prepoly reactor | | | |
| Catalyst | CAT | CAT | CAT |
| Catalyst feed (g/h) | 32 | 35 | 29.9 |
| Temperature (° C.) | 50 | 50 | 50 |
| Pressure (kPa) | 5606 | 5617 | 5614 |
| C2 (kg/h) | 4.0 | 4.0 | 4.0 |
| H2 (g/h) | 0.03 | 0.03 | 0.03 |
| C4 (g/h) | 78.8 | 80.6 | 93.1 |
| Split (wt.-%) | 3.6 | 3.5 | 3.6 |
| loop 1 Fraction (A-1) | | | |
| Temperature (° C.) | 85 | 85 | 85 |
| Pressure (kPa) | 5606 | 5537 | 5536 |
| C2 conc. (mol %) | 4.0 | 3.9 | 4.3 |
| H2/C2 ratio (mol/kmol) | 0.39 | 0.50 | 1.34 |
| C4/C2 ratio (mol/kmol) | 41.0 | 40.0 | 88.0 |
| Split (wt.-%) | 17.9 | 17.8 | 18.2 |
| Density (kg/m³) of loop 1 | 940.1 | 943.0 | 938.3 |
| material (fraction (A-1)) | | | |
| MFR₂ (g/10 min) of loop 1 | 2.2 | 10.0 | 120.0 |
| material (fraction (A-1)) | | | |
| loop 2 | | | |
| Temperature (° C.) | 85 | 85 | 85 |
| Pressure (kPa) | 5535 | 5337 | 5350 |
| C2 conc. (mol %) | 4.2 | 4.1 | 4.3 |
| H2/C2 ratio (mol/kmol) | 0.5 | 0.5 | 0.85 |
| C4/C2 ratio (mol/kmol) | 27 | 28 | 62.1 |
| Split (wt.-%) | 20.7 | 20.0 | 20.2 |
| Density (kg/m³) after | 940.3 | 942.3 | 941.3 |
| loop 2 (component (A)) | | | |
| MFR₂ (g/10 min) after | 4.7 | 7.5 | 122 |
| loop 2 (component (A)) | | | |
| MFR₂ (g/10 min) of loop 2 | 10.4 | 5.5 | 124.2 |
| material (fraction (A-2)) | | | |
| Density (kg/m³) of loop 2 | 940.5 | 941.0 | 944.5 |
| material (fraction (A-2)) | | | |
| C4 (wt.-%) after loop 2 | 1.19 | 1.21 | 2.63 |
| material (Component (A)) | | | |
| GPR | | | |
| Temperature (° C.) | 75 | 75 | 75 |
| Pressure (kPa) | 2000 | 2000 | 2000 |
| H2/C2 ratio (mol/kmol) | 1.02 | 1.05 | 0.77 |
| C6/C2 ratio (mol/kmol) | 11.78 | 14.04 | 10.06 |
| Split (wt.-%) | 57.9 | 58.7 | 58.1 |
| MFR₂ (g/10 min) of GPR | 0.3 | 0.3 | 0.01 |
| material (Component (B)) | | | |
| Density (kg/m³) of GPR | 900.0 | 891.0 | 898.0 |
| material (Component (B)) | | | |
| C6 (wt.-%) of GPR | 12.08 | 18.23 | 13.96 |
| material (Component (B)) | | | |

The polymers (MMCP1-3) were mixed with 2400 ppm of Irganox B561 (commercially available from BASF SE) and 270 ppm of Dynamar FX 5922 (commercially available from 3M) compounded and extruded under nitrogen atmosphere to pellets by using a JSW extruder so that the SEI was 230 kWh/kg and the melt temperature 250° C. Table 3 summarizes some properties of MMCP1-3 and FK1820.

TABLE 3
Properties of multimodal copolymers.

| Properties | Unit | MMCP1 | MMCP2 | MMCP3 | FK1820 |
|---|---|---|---|---|---|
| MFR₂ | g/10 min | 1.0 | 1.0 | 0.63 | 1.5 |
| MFR₅ | g/10 min | 3.1 | 3.0 | 2.1 | 3.6 |
| MFR₂₁ | g/10 min | 29.6 | 30.1 | 28.5 | 27.3 |
| MFR₂₁/MFR₂ | — | 29.6 | 30.1 | 43.8 | 18.2 |
| Density | kg/m³ | 917.1 | 913.0 | 916.2 | 918.0 |
| C4 | wt.-% | 0.5 | 0.5 | 1.1 | 0.6 |
| C6 | wt.-% | 7.0 | 10.7 | 8.2 | 8.1 |

### C. Manufacturing of 3-Layered Films

3-layered films having the composition shown in Table 4 with a total thickness of 60 μm were produced on a Collin 3 layer lab line (BUR=1:2.5, take up speed=7 m/min and melt temperature=210° C.).

### D. Results

TABLE 4
Composition and properties of 3-layered films.

| | | IE1 | IE2 | CE1 | CE2 | CE3 |
|---|---|---|---|---|---|---|
| Skin layer | FK1820 [wt.-%] | — | — | 18 | 18 | 18 |
| (12 μm) | MMCP1 [wt.-%] | — | 18 | — | — | — |
| | MMCP3 [wt.-%] | 18 | — | — | — | — |
| | FT5236 | 2 | 2 | 2 | 2 | 2 |
| Core layer | ZNCP [wt.-%] | 48 | — | 48 | — | — |
| (36 μm) | MMCP2 [wt.-%] | — | 12 | — | — | — |
| | FX1001 [wt.-%] | — | 48 | — | 48 | 48 |
| | FK1820 [wt.-%] | — | — | 12 | 12 | 12 |
| | MMCP3 [wt.-%] | 12 | — | — | — | — |
| Seal layer | FK1820 [wt.-%] | 8 | — | 8 | 8 | — |
| (12 μm) | MMCP2 [wt.-%] | — | 20 | — | — | 20 |
| | Queo0201 [wt.-%] | 12 | — | 12 | 12 | — |

Properties

| | | | | | | |
|---|---|---|---|---|---|---|
| TM (MD) | MPa | 373 | 307 | 385 | 282 | 354 |
| TM (TD) | MPa | 451 | 356 | 455 | 349 | 417 |
| DDI | g | 548 | 863 | 383 | 630 | 567 |
| SIT | ° C. | 81 | 66 | 82 | 75 | 68 |
| TM(MD)*DDI/SIT | | 2523 | 4014 | 1798 | 2369 | 2951 |

wt.-% based on the total weight of the 3-layered film.

### E. Discussion of the Results

The produced films have a core layer made of a specific blend of a metallocene-catalysed multimodal polyethylene copolymer (MMCP) and a multimodal Ziegler-Natta catalysed linear low density polyethylene (ZNCP). The MMCP used in the films according to the present invention inter alia has a ratio of the MFR₂₁ (190° C., 21.6 kg, ISO 1133) to MFR₂ (190° C., 2.16 kg, ISO 1133), MFR₂₁/MFR₂, in the range of 22 to 70. Due to the identical sealing layers, the film according to IE1 is comparable with the films to CE1 and CE2. As can be gathered from above Table 4 the film according to the present invention has a superior impact/stiffness ratio.

Furthermore, the film according to the present invention has an improved balance of mechanical and sealing properties (see™ (MD) *DDI/SIT which is 2523 vs. 1798 and 2369). The film according to IE2 is comparable with the film according to CE3 and shows not only improved impact properties expressed by the Dart Drop Impact Strength, but also improved sealing properties expressing by the Sealing Initiation Temperature (see also™ (MD) *DDI/SIT which is 4014 vs. 2951). The selection of the materials in the core layer significantly influences the properties of the multilayer film.

1-15. (canceled)

16. A multilayered film comprising:
a skin layer (SKL), a core layer (CL) and a sealing layer (SL); wherein the core layer (CL) includes:
(a) 5 to 40 wt.-% based on a total weight of the core layer (CL) of a metallocene-catalysed multimodal polyethylene copolymer (MMCP) having:
a density (ASTM D792) in a range of 880 to 925 kg/m³;
a MFR₂ (190° C., 2.16 kg, ISO 1133) in a range of 0.1 to 6.0 g/10 min; and
a ratio of a MFR₂₁ (190° C., 21.6 kg, ISO 1133) to MFR₂ (190° C., 2.16 kg, ISO 1133), MFR₂₁/MFR₂, in a range of 22 to 70; and
(b) 60 to 95 wt.-% based on the total weight of the core layer (CL) of a multimodal Ziegler-Natta catalysed linear low density polyethylene (ZNCP) having:
a density (ASTM D792) in a range of 925 to 950 kg/m³; and
a MFR₅ (190° C., 5 kg, ISO 1133) in a range of 0.1 to 6.0 g/10 min; wherein components (a) and (b) add up to 100 wt.-%.

17. The multilayered film according to claim 16, wherein, the metallocene-catalysed multimodal polyethylene copolymer (MMCP) consists of:
an ethylene polymer component (A), being a copolymer of ethylene with 1-butene, which consists of an ethylene polymer fraction (A-1) and an ethylene polymer fraction (A-2); and
an ethylene polymer component (B), being a copolymer of ethylene and 1-hexene; wherein
a total amount of 1-butene based on the MMCP is in a range of 0.1 to 1.5 wt.-%, and/or 0.2 to 1.3 wt.-%, and/or 0.4 to 1.2 wt.-% or 0.4 to 0.6 wt.-%; and/or a total amount of 1-hexene based on the MMCP is in a range of 2.0 to 20.0 wt.-%, and/or 4.0 to 18.0 wt.-%, and/or 6.0 to 15.0 wt.-%.

18. The multilayered film according to claim 17, wherein, he metallocene-catalysed multimodal polyethylene copolymer (MMCP) comprises:
a total amount of 1-butene in the ethylene polymer component (A) in a range of 0.5 to 5.0 wt.-%, and/or of 0.6 to 4.0 wt.-%, and/or of 0.8 to 3.0 wt.-%, and/or of 1.0 to 2.0 wt.-%, based on a total weight of the ethylene polymer component (A); and/or
a total amount of 1-hexene in the ethylene polymer component (B) in a range of 3.0 to 25.0 wt.-%, and/or of 4.0 to 22.0 wt.-%, and/or of 10.0 to 20.0 wt.-%, based on a total weight of ethylene polymer component (B); and/or
a MFR₂ (190° C., 2.16 kg, ISO 1133) of the ethylene polymer fraction (A-1) in a range of 1.0 to 15.0 g/10 min or 100 to 140 g/10 min, and/or of 1.5 to 13.0 g/10 min or 110 to 130 g/10 min, and/or of 2.0 to 11.0 g/10 min or 115 to 125 g/10 min, and/or of 2.0 to 10.5 g/10 min or 117 to 124 g/10 min; and/or
a MFR₂ (190° C., 2.16 kg, ISO 1133) of the ethylene polymer fraction (A-2) in a range of 2.0 to 30.0 g/10 min or 100 to 140 g/10 min, and/or of 2.5 to 20.0 g/10 min or 110 to 130 g/10 min and/or of 3.0 to 15.0 g/10 min or 115 to 125 g/10 min; and/or
a MFR₂ (190° C., 2.16 kg, ISO 1133) of ethylene polymer component (A) in a range of 2.0 to 30.0 g/10 min or 100 to 140 g/10 min, and/or of 2.5 to 20.0 g/10 min or 110 to 130 g/10 min, and/or of 3.0 to 15.0 g/10 min or 115 to 128 g/10 min and/or of 3.2 to 10.0 g/10 min or 120 to 125 g/10 min; and/or
a MFR₂ (190° C., 2.16 kg, ISO 1133) of ethylene polymer component (B) in a range of 0.001 to 1.5 g/10 min, and/or of 0.01 to 1.5 g/10 min, and/or of 0.05 to 1.2 g/10 min, and/or of 0.1 to 1.0 g/10 min and/or of 0.2 to 0.7 g/10 min; and/or
a ratio of the MFR₂ (190° C., 2.16 kg, ISO 1133) of ethylene polymer component (A) to the MFR₂ (190° C., 2.16 kg, ISO 1133) of MMCP in a range of 2.5 to 20.0, and/or of 3.0 to 15.0, and/or of 3.5 to 10.0.

19. The multilayered film according to claim 17, wherein, the metallocene-catalysed multimodal polyethylene copolymer (MMCP) has:
a density (ASTM D792) of the ethylene polymer component (A) in a range of 920 to 950 kg/m³, and/or of 925 to 950 kg/m³, and/or of 930 to 945 kg/m³; and/or
a density (ASTM D792) of the ethylene polymer component (B) in a range of 880 to 915 kg/m³, and/or of 885 to 910 kg/m³, and/or of 890 to 905 kg/m³; and/or
a density (ASTM D792) of the polymer fraction (A-1) in a range of 920 to 960 kg/m³, and/or of 925 to 955 kg/m³, and/or of 930 to 950 kg/m³; and/or
a density (ASTM D792) of the polymer fraction (A-2) in a range of 930 to 950 kg/m³, and/or of 935 to 945 kg/m³; and/or
the metallocene-catalysed multimodal polyethylene copolymer (MMCP) itself has a density (ASTM D792) in a range of 900 to 925 kg/m³ and and/or of 910 to 925 kg/m³.

20. The multilayered film according to claim 16, wherein, the metallocene-catalysed multimodal polyethylene copolymer (MMCP) is configured from a presence of a metallocene complex of formula (I): 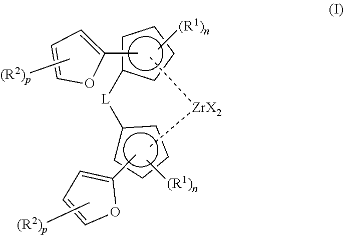
wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is a same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

21. The multilayered film according to claim 16, wherein the multimodal Ziegler-Natta catalysed linear low density polyethylene (ZNCP) comprises
(C) a lower molecular weight (LMW) homopolymer of ethylene; and
(D) a higher molecular weight (HMW) terpolymer of ethylene, 1-butene and 1-hexene; wherein:
the LMW homopolymer fraction (C) has a lower molecular weight than the HMW terpolymer fraction (D);
the lower molecular weight fraction (C) of the ZNCP has:
i) a MFR₂ (190° C., 2.16 kg, ISO 1133) in a range of 200 to 1000 g/10 min and/or of 250 to 800 g/10 min;
ii) a density (ASTM D792) a range of 940 to 980 kg/m³, and/or 945 to 975 kg/m³; and
iii) a comonomer content in a range of 0 to 2.5 mol-% and/or of 0 to 2.0 mol-%; and
the higher molecular weight fraction (D) has a lower MFR₂ and a lower density than the lower molecular weight fraction (C).

22. The multilayered film according to claim 21, wherein, the lower molecular weight (LMW) homopolymer of ethylene (C) consists of two homopolymer fractions (C-1) and (C-2); wherein:
the homopolymer fraction (C-1) has a MFR₂ (190° C., 2.16 kg, ISO 1133) in a range of 100 to 400 g/10 min, and/or in a range of 150 to 300 g/10 min; and/or
the homopolymer fraction (C-2) has a MFR₂ (190° C., 2.16 kg, ISO 1133) in a range of 450 to 1200 g/10 min, and/or in a range of 600 to 1100 g/10 min; and/or
the MFR₂ of fraction (C-1) is lower than the MFR₂ of the total lower molecular weight (LMW) homopolymer of ethylene (C); and/or
the density of the two homopolymer fractions (C-1) and (C-2) may be the same or may be different and is in a range of 955 to 980 kg/m³, and/or 965 to 980 kg/m³, and/or 965 to 975 kg/m³.

23. The multilayered film according to claim 16, wherein, the core layer (CL) comprises and:
(a) 10 to 25 wt.-% and/or 18 to 22 wt.-% based on a total weight of the core layer (CL) of the metallocene-catalysed multimodal polyethylene copolymer (MMCP); and
(b) 75 to 90 wt.-% and/or 78 to 82 wt.-% based on a total weight of the core layer (CL) of a multimodal Ziegler-Natta catalysed linear low density polyethylene (ZNCP); wherein:
components (a) and (b) add up to 100 wt.-%.

24. The multilayered film according to claim 16, wherein, the multilayered film consists of the skin layer (SKL), the core layer (CL) and the sealing layer (SL); and/or
the skin layer (SKL) comprises:
80 to 95 wt.-%, and/or 82 to 93 wt.-%, and/or 88 to 92 wt.-% based on a total weight of the skin layer (SKL) of the metallocene-catalysed multimodal polyethylene copolymer (MMCP); and
5 to 20 wt.-%, and/or 7 to 18 wt.-%, and/or 8 to 12 wt.-% based on a total weight of the skin layer (SKL) of a LDPE having a density (ASTM D792) in a range of 920 to 940 kg/m³, and/or of 930 to 936 kg/m³, and a MFR₂ (190° C., 2.16 kg, ISO 1133) in a range of 0.5 to 4.0 g/10 min, and/or of 0.1 to 1.0 g/10 min.

25. The multilayered film according to claim 16, wherein, the multilayer film consists of the skin layer (SKL), the core layer (CL) and the sealing layer (SL); and/or
the sealing layer (SL) comprises:
90 to 100 wt.-%, and/or 95 to 100 wt.-% based on a total weight of the sealing layer (SL) of the metallocene-catalysed multimodal polyethylene copolymer (MMCP), and/or the sealing layer consists of the MMCP; or
50 to 70 wt.-%, and/or 55 to 65 wt.-% based on a total weight of the sealing layer (SL) of a plastomer, being a copolymer of ethylene and 1-octene, having a density (ASTM D792) in a range of 860 to 910 kg/m³, and/or of 895 to 905 kg/m³, and a MFR₂ (190° C., 2.16 kg, ISO 1133) in a range of 0.5 to 10.0 g/10 min, and/or of 1.0 to 1.5 g/10 min; and 30 to 50 wt.-%, and/or 35 to 45 wt.-% based on a total weight of the sealing layer (SL) of a multimodal metallocene catalysed linear low density polyethylene being a bimodal ethylene/1-butene/1-hexene terpolymer, having a density (ASTM D792) in a range of 910 to 930 kg/m³, and/or of 916 to 925 kg/m³; and a MFR₂ (190° C., 2.16 kg, ISO 1133) in a range of 0.5 to 2.0 g/10 min.

26. The multilayered film according to claim 16, wherein:
the skin layer (SKL) of the multilayered film has a thickness in the range of 1 to 100 μm, and/or in a range of 5 to 80 μm, and/or in a range of 10 to 15 μm; and/or
the core layer (CL) of the multilayered film has a thickness in a range of 10 to 200 μm, and/or in a range of 20 to 80 μm, and/or in a range of 30 to 45 μm; and/or
the sealing layer (SL) of the multilayered film has a thickness in a range of 1 to 50 μm, and/or in a range of 5 to 25 μm, and/or in a range of 10 to 15 μm; and/or
the multilayered film has a thickness in a range of 12 to 350 μm, and/or in a range of 40 to 150 μm, and/or in a range of 50 to 70 μm.

27. The multilayered film according to claim 16, wherein said multilayered film comprises:
a Tensile Modulus in MD (ISO 527-3) in a range of 200 to 500 MPa, and/or in a range of 280 to 400 MPa; and/or
a Tensile Modulus in TD (ISO 527-3) in a range of 250 to 600 MPa, and/or in a range of 340 to 500 MPa; and/or
a Dart Drop Strength (ISO 7765-1) in a range of 500 to 1000 g, and/or in the range of 800 to 950 g.

28. The multilayered film according to claim 16, wherein said multilayered film has a Sealing Initiation Temperature determined as described in a specification in a range of 60 to 85° C. and/or in a range of 63 to 68° C.

29. The multilayered film article according to claim 16, wherein said multilayered film consists of polyethylene-based polymers.

30. The multilayered film according to claim 16, configured as packaging material for food and/or medical products.
